(19) United States
(12) Patent Application Publication
(10) Pub. No.: US 2008/0048069 A1
(43) Pub. Date: Feb. 28, 2008

(54) Uncoupled vibrion attenuation/isolation devices

(76) Inventors: Gangtie Zheng, Beijing (CN); Likun Liu, Beijing (CN); Lu Liang, Tianjin (CN); Ling He, Harbin (CN)

Correspondence Address: MORRISON & FOERSTER LLP, 12531 HIGH BLUFF DRIVE, SUITE 100, SAN DIEGO, CA, 92130-2040, US

(21) Appl. No.: 11/601,547

(22) Filed: Nov. 16, 2006

(30) Foreign Application Priority Data
Aug. 25, 2006 (CN) 200610010442.X

(51) Int. Cl. B64G 1/52; F16F 7/10

(52) U.S. Cl. 244/171.7; 188/379

(57) ABSTRACT

The present invention relates to a vibration attenuation/isolation device. An implementation of the invention provides an improved whole-spacecraft vibration attenuation/isolation by separating the vibration load on the spacecraft that arise from the launch vehicle and fairing into longitudinal and lateral components, and effectively attenuates and/or isolates those components. The invention also provides a general method for reducing vibrations in an assembly by using a vibration control device that separates the vibrational forces into perpendicular components that can be separately damped or attenuated.

### RELATED APPLICATION

This application is related to Chinese national patent application No. 200610010442.X, filed Aug. 25, 2006, entitled “UNCOUPLED WHOLE-SPACECRAFT VIBRATION ATTENUATION/ISOLATION DEVICE.” The disclosure of the above Chinese national patent application is incorporated by reference in its entirety.

### Technical Field

This invention relates to a vibration attenuation/isolation device and method that reduces vibrations transmitted between two structures joined into one assembly. The device provides two perpendicular sliding surfaces that separate vibrational forces into perpendicular components, then separately damps or attenuates each of these components. Therefore, it is given the name of Uncoupled Vibration Attenuation/Isolation Devices. One implementation of the invention is a whole-spacecraft vibration attenuation/isolation device and method with improved effectiveness over those known in the art: the invention uses an uncoupler device to separate or uncouple the vibration load on the spacecraft from launch vehicle and fairing into longitudinal and lateral components, and effectively attenuates/isolates the separated vibration loads, and in the meantime it does not amplify the bending motion of the spacecraft/LV assembly.

### BACKGROUND ART

A spacecraft (SC) is a vessel that carries passengers and/or equipment outside earth's atmosphere. It is designed to escape from earth's gravitational field, and is thus typically relatively light compared to the engines and fuel load that are required to launch it from earth, which are collectively referred to herein as the Launch Vehicle (LV). To attain escape velocity for launch into a stable orbit or beyond the substantial effects of earth's gravitational field, the spacecraft is typically boosted into orbit by an LV, and the heavier LV is then jettisoned. However, during the launch and acceleration phase, the LV and SC are connected into an assembly that experiences tremendous physical stresses, both longitudinally (along the major axis of the assembly) and laterally (perpendicular to the major axis of the assembly). Therefore, it is important for the linkage between the SC and LV to be strong enough to withstand these longitudinal and lateral forces.

The launch stage is the most severe dynamic environment that a spacecraft will experience during its mission life. In order to survive the severe vibration load, the structure of the spacecraft must be strengthened and/or the sensitive equipment must be isolated locally. However, all these measures will add some weight to the spacecraft that will be useless later in the orbit, and thus decrease the ratio of payload mass to structure mass of the spacecraft. Payload attach fitting (PAF) is the section connecting the launch vehicle (LV) with the spacecraft, and is traditionally designed to be very stiff and provide an efficient transmission path for both dynamic and quasi-static launch loads. However, a rigid connection transmits vibrational forces generated by the powerful LV to the often fragile payload carried by the SC. Thus a means to connect SC and LV that minimizes the transmission of destructive vibrational forces is needed. The whole-spacecraft vibration attenuation/isolation (WSVA/I) device as an implementation of the present invention can effectively decrease vibration load transmitted to the spacecraft by modifying or replacing the original PAF. As a direct result, the dynamic environment provided by the launch vehicle to the spacecraft can be significantly improved, and potential damage to the SC and/or its payload can be avoided.

The fundamental problem to implement the WSVA/I is that there are different requirements on the longitudinal and lateral break frequencies, and in the meantime the bending stiffness should not be decreased to avoid large displacement at the top of the spacecraft in the fairing. The present invention provide a kind of device, which can decompose the vibration load on the spacecraft from launch vehicle and fairing into longitudinal and lateral components and effectively attenuate/isolate them respectively by having different break frequencies in the longitudinal direction and the lateral direction but without reducing the bending stiffness of the assembly.

One embodiment of the device of this invention includes a spacecraft-link portion and a LV-link portion, which are securely attached to or incorporated into the spacecraft and launch vehicle, respectively. It further includes at least one vibration attenuation/isolation feature, which may be a longitudinal vibration attenuation/isolation portion, or a lateral vibration attenuation/isolation portion; frequently, embodiments of the invention include both a longitudinal vibration attenuation/isolation portion and a lateral vibration attenuation/isolation portion. The spacecraft-link portion is connected to the LV-link portion by the longitudinal vibration attenuation/isolation portion and/or lateral vibration attenuation/isolation portion.

Although the vibration from the launch vehicle and transmitted from the fairing to the bottom of the PAF can be in any direction, it can always be considered as a linear combination of components along the longitudinal direction and the lateral directions. Here the longitudinal direction is defined as the direction of the symmetric axis of the launch vehicle, i.e., essentially vertical when a typical rocket-style SC-LV assembly is positioned for launch, and the lateral direction is perpendicular to this axis, or essentially horizontal. For a traditional WSVA/I device, the longitudinal vibration and lateral vibration transmit to the spacecraft along the same path, and the longitudinal break frequency and the lateral break frequency rely on and can interact with each other. To improve performance of vibration attenuation/isolation, the longitudinal and lateral stiffness of the component connecting the LV and the spacecraft are typically decreased, and as a result, the bending stiffness of the assembly is unavoidably decreased, which may increase the chance that the SC and the fairing may collide onto each other and thus be damaged.

The present invention provides a new concept for the design of WSVA/I device, in which the device is divided into three parts: a spacecraft-link portion, an LV-link portion, and at least one longitudinal vibration attenuation/isolation portion or lateral vibration attenuation/isolation portion. The spacecraft-link portion is connected to the LV-link portion by the longitudinal vibration attenuation/isolation portion or the lateral vibration attenuation/isolation portion. With this new design, these forces can be separated or decomposed into longitudinal and lateral components, which can then be separately attenuated and/or isolated, and therefore the vibration load on the spacecraft from launch vehicle and fairing is reduced substantially.

In the device of the invention, longitudinal vibration load and lateral vibration load are uncoupled. Therefore, the implementation of this invention is given the name of Uncoupled Vibration Attenuation/isolation Device. The longitudinal vibration attenuation/isolation portion and the lateral vibration attenuation/isolation portion can choose passive actuators or active actuators, and large damping can be added to attenuate the peak transmissibility, or low stiffness and proper damping can be used together to achieve the effect of vibration isolation.

The design principle used to address the problems of vibration in a spacecraft-launch vehicle assembly can also be applied to other systems. Generally, vibrations in an assembly can be reduced by employing a device such as the one described above to connect separate structures into an assembly. The device will use at least one and typically two bilateral sliding constraint surfaces to direct the vibrational forces transmitted between the two structures into one or more vibration attenuating devices such as an elastic element or a damping element. In many embodiments of this method for reducing vibrations in an assembly, the vibration control device comprises a pair of substantially perpendicular bilateral sliding constraint surfaces to separate the vibrational forces into perpendicular components. The device typically then employs at least one vibration damper and/or elastic element, and frequently it includes more than one such element, such as a vibration damper and an elastic element that function together to provide damping of one component of the vibrational force. Thus the invention provides a method to design a vibration control device for an assembly, and a method to control vibrations in an assembly using devices such as those described herein.

### BRIEF DESCRIPTION OF THE DRAWINGS

FIG. 1 is the diagrammatic front view of a WSVA/I device of this invention according to the first example.

FIG. 2 is the diagrammatic front view of a WSVA/I device of this invention according to the second example.

FIG. 3 is the diagrammatic front view of a WSVA/I device of this invention according to the third example.

FIG. 4 is the top view of FIG. 3.

FIG. 5 is an A-A cross-sectional view of FIG. 3.

FIG. 6 is the diagrammatic front view of a WSVA/I device of this invention according to the fourth example.

FIG. 7 is the top view of FIG. 6.

FIG. 8 is an A-A cross-sectional view of FIG. 6.

FIG. 9 is an engineering realization of a WSVA/I device of this invention according to FIG. 3.

FIG. 10 is an exploded view of the embodiment of FIG. 9, showing the vibration control elements.

FIG. 11 is a computational model of the third example topped with a spacecraft model.

FIG. 12 shows longitudinal vibration transmissibility curves illustrating the transmission of acceleration from the bottom of the PAF to the bottom of the spacecraft, where the dotted line denotes a computational model in which the WSVA/I device is not used, and the solid line denotes one where the WSVA/I device of the invention is used.

FIG. 13 shows lateral vibration transmissibility curves illustrating the transmission of vibrational acceleration from the bottom of the PAF to the bottom of the spacecraft, where the dotted line denotes a computational model where the WSVA/I device is not used, and the solid line denotes a computational model in which the WSVA/I device is used.

### DISCLOSURE OF THE INVENTION

One embodiment of the present invention, referred to as an Uncoupled Whole-Spacecraft Vibration Attenuation/Isolation Device (UWSVA/I), provides a new concept for controlling vibrations in a SC-LV assembly. The UWSVA/I abandons the conventional idea that the longitudinal and lateral vibration loads transmit along the same path to the bottom of the spacecraft. By adopting the independent longitudinal and lateral vibration attenuation/isolation portions, the vibration load is decomposed or resolved into the longitudinal and lateral components, and these components transmit to the spacecraft separately along different paths. Therefore, they can not only meet different requirements of the longitudinal and lateral vibration attenuation/isolation, but also does not decrease the bending stiffness of the connection between the launch vehicle and the spacecraft.

To describe one embodiment of the invention, the device is divided into four parts: a spacecraft-link portion, a longitudinal vibration attenuation/isolation portion, a lateral vibration attenuation/isolation portion, and a LV-link portion. The spacecraft-link portion is connected to the LV-link portion by the longitudinal vibration attenuation/isolation portion and the lateral vibration attenuation/isolation portion.

The link stiffness between the spacecraft and LV is important for the vibration environment of the spacecraft. For a good performance of WSVA/I, the link stiffness is desired to be as low as possible. However, to avoid resonance with the LV, the lowest frequencies of the first longitudinal and lateral main mode should be higher than certain values. For most LVs, the lowest natural frequency of the spacecraft in the longitudinal direction is usually set as 30 Hz, and the lowest natural frequency in the lateral direction is usually set as 10 Hz.

The longitudinal link stiffness and the lateral link stiffness of traditional PAF devices are coupled together, so it is nearly impossible for the longitudinal and lateral link stiffnesses to reach their limit values simultaneously. For most cases, the longitudinal stiffness can reach its limit only when lateral stiffness is reduced to an extent that may be unacceptable.

The longitudinal link stiffness and the lateral link stiffness between the spacecraft and LV can be decoupled by a properly designed WSVA/I device of the present invention. To illustrate these devices only, and without limiting the scope of the invention, some examples are provided herein, and are depicted in the accompanying Figures.

### MODES OF CARRYING OUT THE INVENTION

Some embodiments of the invention include devices having one or more vibration attenuation/isolation portions, such as a longitudinal one and a lateral one, for separating vibrational forces into perpendicular components that can be separately managed or attenuated. The longitudinal vibration attenuation/isolation portion and the lateral vibration attenuation/isolation portion are composed of elastic elements, damping elements and bilateral sliding constraint surfaces.

The bilateral sliding constraint surfaces are relatively rigid surfaces that channel or direct forces in one direction; they are not intended to absorb or cushion the forces, only to channel them in one direction. Typically, each bilateral sliding constraint surface is used in combination with at least one element that can attenuate the vibrational force it directs. Thus, in the examples described below, where the application of the device is in a substantially cylindrical assembly, one of the bilateral sliding constraint surfaces may be cylindrical and permit longitudinal relative motion between the two structures joined by the device, where the longitudinal motion occurs parallel to a central axis of the assembly. That surface would generally be used in combination with at least one damping and/or elastic element that attenuates motion or forces parallel to the central axis. The other bilateral sliding constraint surface may be radial in shape in this example, permitting lateral motion in any direction perpendicular to the central axis of the assembly. That surface may be used in combination with at least one, and preferably a plurality of elastic elements and/or damping elements that attenuate forces or vibrations that are directed perpendicular to the central axis. Thus the devices of the invention typically include a constraining surface that directs motion into one direction, that operates in concert with at least one element to attenuate or absorb motion in that direction.

The elastic element can be any structure that provides only elastic deformation, and can support the spacecraft and transmit force from the LV to the SC, such as a helical spring, laminated spring, leaf spring, metal rubber or other element that are designed to meet suitable stiffness and deformation requirements for the specific application. The damping element can be any structure that provides damping forces in a given direction, such as a viscosity liquid damper, an electromagnet eddy damper, a magnetorheological damper, etc. The bilateral sliding constraint surface can be implemented by a nearly frictionless surface or a frictional surface that can dissipate vibration energy. Typically, this surface is designed to avoid substantial deformation under normal working loads, and thus serves to channel forces in a direction parallel to its surface and to direct them to an element that can attenuate the force or motion.

The device of the invention can be made of any materials suitable for use in such applications; suitable materials for the device and methods for making them are well known to those of ordinary skill in the art. Some embodiments are made of material known to be suitable for use in WSVA/I device, including, for example, alloys of aluminum, alloys of titanium, carbon-fiber composite materials. Alloy materials are used at the places where a bolted or welded linkage is needed, for example, and the carbon-fiber materials are often used in other components to decrease weight of the whole device.

In some embodiments, the longitudinal vibration attenuation/isolation portion is outside the lateral vibration attenuation/isolation portion. In some embodiments, the longitudinal vibration attenuation/isolation portion is inside the lateral vibration attenuation/isolation portion.

In some embodiments, only the longitudinal vibration attenuation/isolation portion is used when vibration load of the structure along the longitudinal direction need to be attenuated or isolated. In some embodiments, only the lateral vibration attenuation/isolation portion is used when vibration load of the structure along the lateral direction needs to be attenuated or isolated.

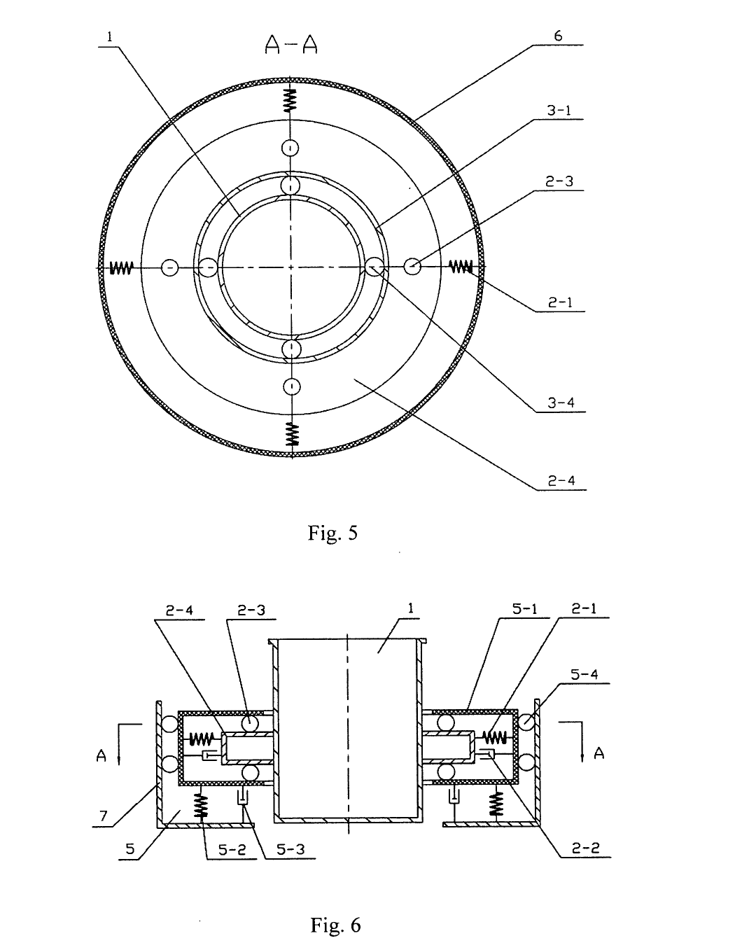

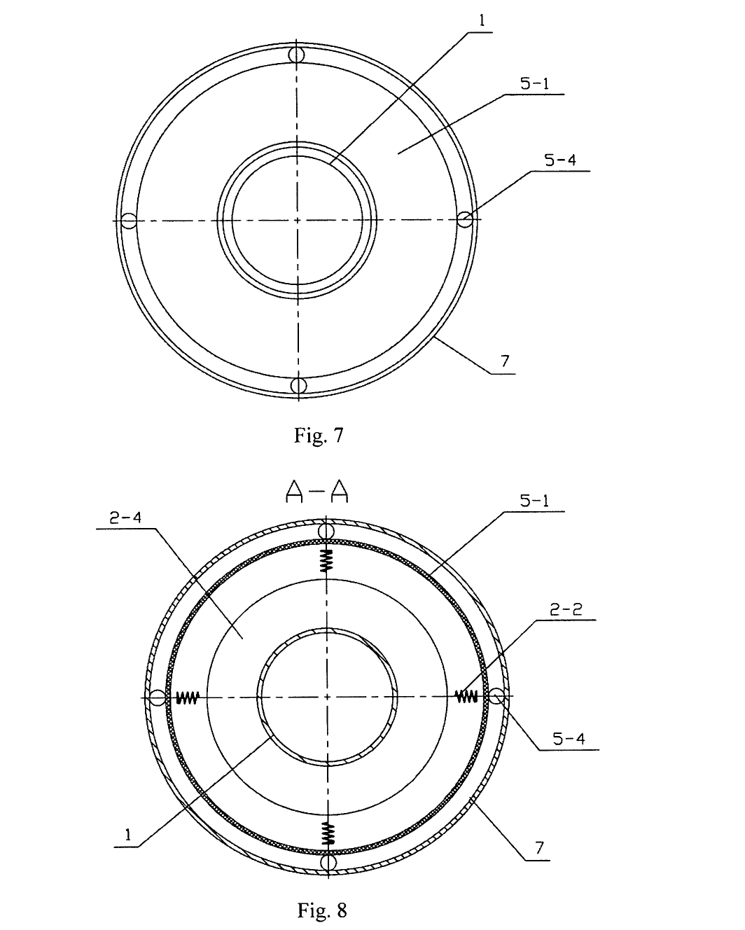

FIGS. 1-8 illustrate a general shape of some embodiments of the device of the invention; the actual relative size of the body compared to the spacecraft and LV may be varied without departing from the invention. Typically, one device of the present invention is adequately sized to connect SC to LV, but one or more than one such device may be used in an SC-LV assembly. The precise design and the performance of a device of the invention can be evaluated by a finite element analysis with constraint conditions that come from requirements of the LV and the spacecraft, for example, or from other structures to be joined into an assembly.

The following examples are provided to illustrate but not to limit the invention.

### EXAMPLE 1

One embodiment of the invention shown as FIG. 1 includes a spacecraft-link portion 1, a longitudinal vibration attenuation/isolation portion 3, and a LV-link portion 4. The longitudinal vibration attenuation/isolation portion 3 is composed of the longitudinal sliding constraint structure 3-1, the longitudinal elastic element 3-2, the longitudinal damping element 3-3, and the longitudinal bilateral sliding constraint surface 3-4. The bottom of the spacecraft-link portion 1 is connected to the LV-link portion 4 by groups of longitudinal elastic elements 3-2 and the longitudinal damping elements 3-3 in parallel. The exterior surface of the spacecraft-link portion 1 is connected to the interior surface of the LV-link portion 4 by the longitudinal bilateral sliding constraint surface 3-4.

The spacecraft-link portion 1 and the LV-link portion 4 construct a longitudinal sliding pair which only allows the spacecraft-link portion 1 to translate along the longitudinal direction relative to the LV-link portion 4. The bottom of the spacecraft-link portion 1 is connected to the bottom of the LV-link portion 4 by groups of the longitudinal elastic elements 3-2 and the longitudinal damping elements 3-3 in parallel, which can attenuate/isolate the longitudinal vibration.

### EXAMPLE 2

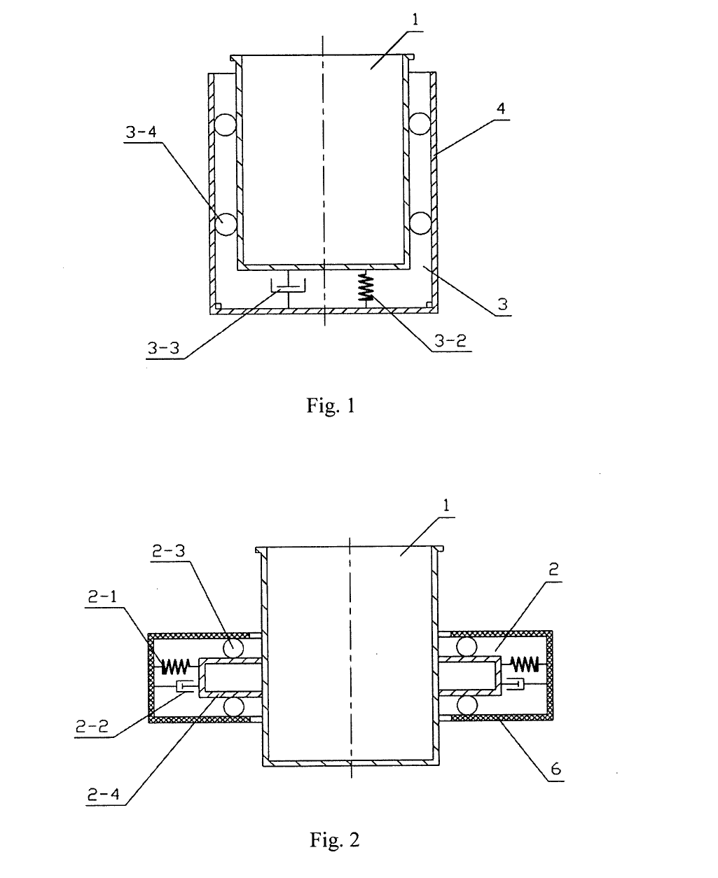

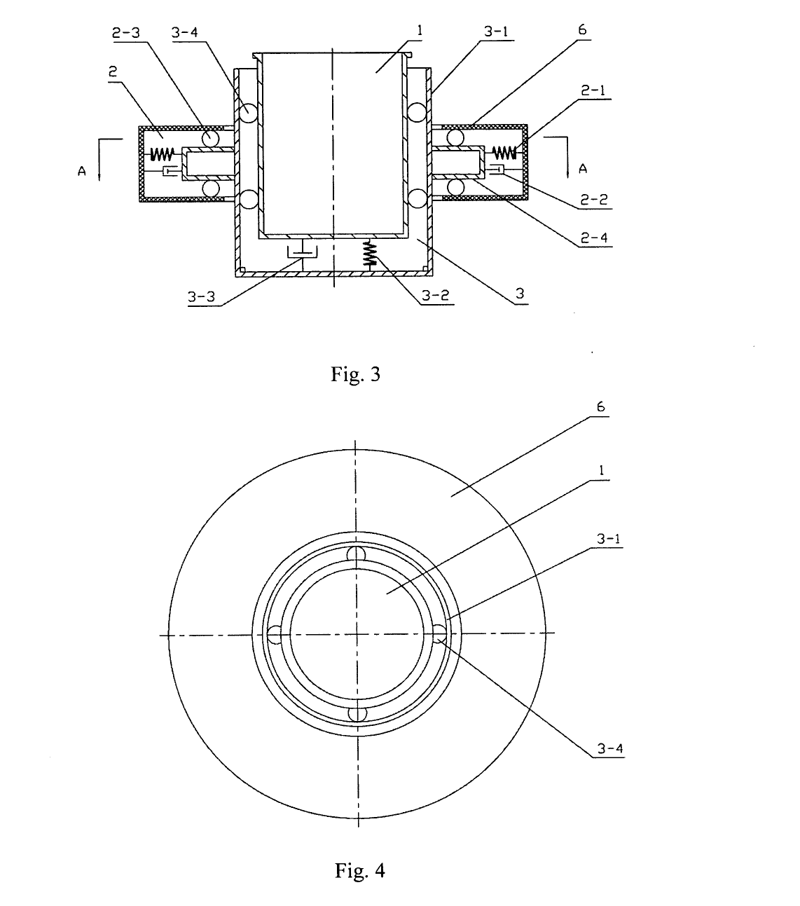

One embodiment of the invention shown as FIG. 2 includes a spacecraft-link portion 1, a lateral vibration attenuation/isolation portion 2, and a LV-link portion II 6. The lateral vibration attenuation/isolation portion 2 is composed of the lateral elastic element 2-1, the lateral damping element 2-2, the lateral bilateral sliding constraint surface 2-3 and the lateral sliding structure 2-4. The exterior surface of the spacecraft-link portion 1 and the interior of the lateral sliding structure 2-4 are fixed together. The exterior surface of the lateral sliding structure 2-4 is connected to the interior surface of the LV-link portion II 6 by groups of lateral elastic elements 2-1 and lateral damping elements 2-2 in parallel. The lateral sliding structure 2-4 is connected the LV-link portion II 6 by the lateral bilateral sliding constraint surface 2-3.

The LV-link portion II 6 and the lateral sliding structure 2-4, which is fixed on the spacecraft-link portion 1, construct a lateral sliding pair which only allows the spacecraft-link portion 1 to translate along the lateral direction relative to the LV-link portion II 6. The exterior surface of the lateral sliding structure 2-4 is connected to the interior surface of the LV-link portion II 6 by groups of the lateral elastic elements 2-1 and the lateral damping elements 2-2 in parallel, which can attenuate/isolate the lateral vibration load.

### EXAMPLE 3

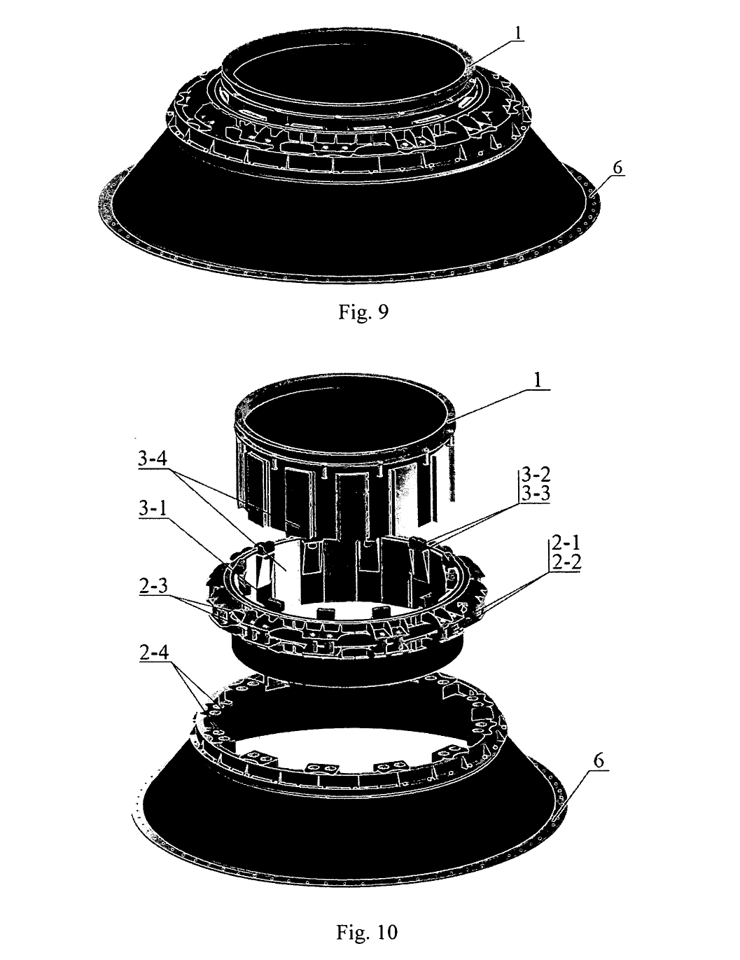

One embodiment of the invention shown as FIGS. 3-5 includes a spacecraft-link portion 1, a lateral vibration attenuation/isolation portion 2, a longitudinal vibration attenuation/isolation portion 3, and a LV-link portion 6. One engineering realization of this embodiment is shown as FIGS. 9-10, which depict the vibration damping elements in more detail. The lateral vibration attenuation/isolation portion 2 is composed of the lateral elastic element 2-1, the lateral damping element 2-2, the lateral bilateral sliding constraint surface 2-3 and the lateral sliding structure 2-4. The longitudinal vibration attenuation/isolation portion 3 is composed of the longitudinal sliding constraint structure 3-1, the longitudinal elastic element 3-2, the longitudinal damping element 3-3, and the longitudinal bilateral sliding constraint surface 3-4. The bottom of the spacecraft-link portion 1 is connected to the longitudinal sliding constraint structure 3-1 by groups of the longitudinal elastic elements 3-2 and the longitudinal damping elements 3-3 in parallel. The exterior surface of the spacecraft-link portion 1 is connected to the interior surface of the longitudinal sliding constraint structure 3-1 by the longitudinal bilateral sliding constraint surface 3-4. The exterior surface of the longitudinal sliding constraint structure 3-1 and the interior of the lateral sliding structure 2-4 are fixed together. The exterior surface of the lateral sliding structure 2-4 is connected to the interior surface of the LV-link portion II 6 by groups of the lateral elastic elements 2-1 and the lateral damping elements 2-2 in parallel. The lateral sliding structure 2-4 is connected to the interior surface of the LV-link portion II 6 by the lateral bilateral sliding constraint surface 2-3.

The spacecraft-link portion 1 and the longitudinal sliding constraint structure 3-1 construct a longitudinal sliding pair which only allows the spacecraft-link portion 1 to translate along the longitudinal direction relative to the longitudinal sliding constraint structure 3-1. The bottom of the spacecraft-link portion 1 is connected to the longitudinal sliding constraint structure 3-1 by groups of the longitudinal elastic elements 3-2 and the longitudinal damping elements 3-3 in parallel, which will attenuate/isolate the longitudinal vibration load. The LV-link portion II 6 and the longitudinal sliding constraint structure 3-1 construct a lateral sliding pair which only allows the LV-link portion II 6 to translate along the lateral direction relative to the longitudinal sliding constraint structure 3-1. The exterior surface of the lateral sliding structure 2-4 is connected to the interior surface of the LV-link portion II 6 by groups of the lateral elastic elements 2-1 and the lateral damping elements 2-2 in parallel, which will attenuate/isolate the lateral vibration load.

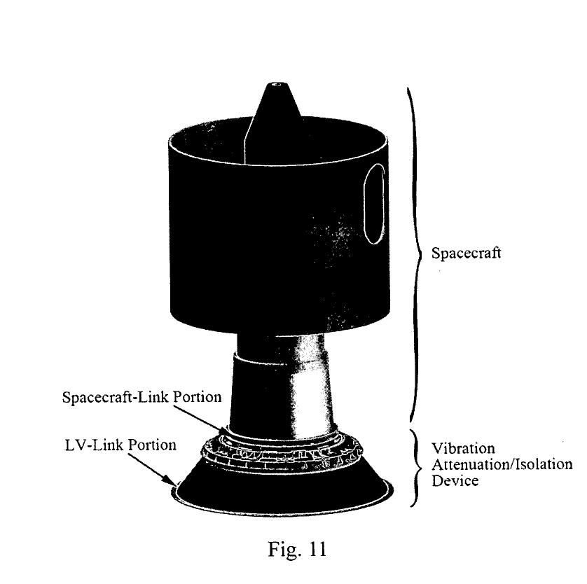

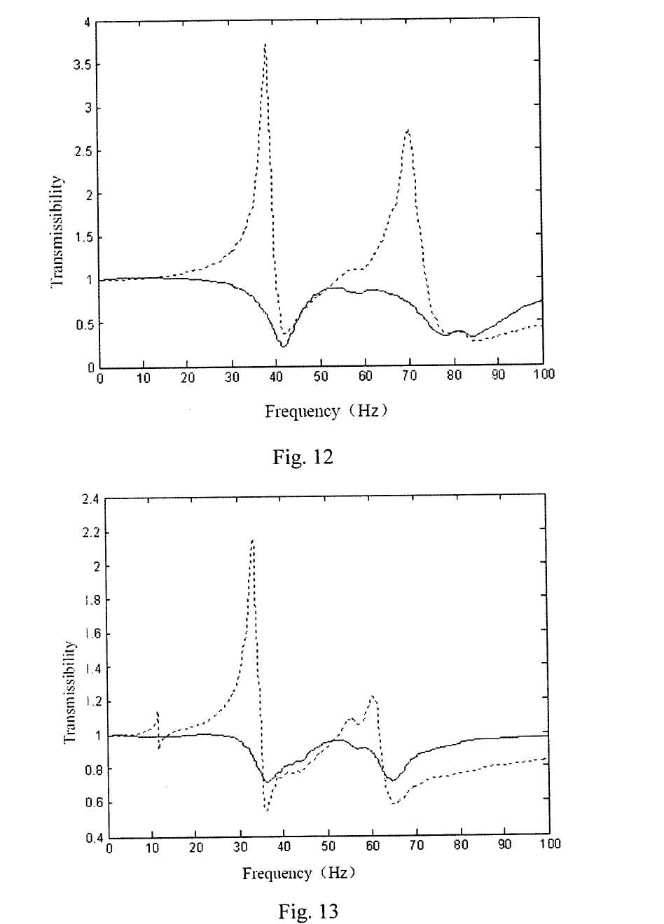

In order to verify the performance of the devices, a computational model of example 3 toped with a computational spacecraft model is built as FIG. 11. The longitudinal and lateral transmission of vibrational acceleration from the bottom of the PAF to the bottom of the spacecraft is calculated as shown in FIG. 12 and FIG. 13. It can be seen that a great vibration attenuation/isolation effect is achieved.

### EXAMPLE 4

One embodiment of the invention shown as FIGS. 6-8 includes a spacecraft-link portion 1, a lateral vibration attenuation/isolation portion 2, a longitudinal vibration attenuation/isolation portion II 5, and a LV-link portion III 7. The lateral vibration attenuation/isolation portion 2 is composed of the lateral elastic element 2-1, the lateral damping element 2-2, the lateral bilateral sliding constraint surface 2-3 and the lateral sliding structure 2-4. The longitudinal vibration attenuation/isolation portion II 5 is composed of the longitudinal sliding constraint structure II 5-1, the longitudinal elastic element II 5-2, the longitudinal damping element II 5-3, and the longitudinal bilateral sliding constraint surface II 5-4. The exterior surface of the spacecraft-link portion 1 and the interior of the lateral sliding structure 2-4 are fixed together. The exterior surface of the lateral sliding structure 2-4 is connected to the interior surface of the longitudinal sliding constraint structure II 5-1 by groups of the lateral elastic elements 2-1 and the lateral damping elements 2-2 in parallel. The lateral sliding structure 2-4 is connected the longitudinal sliding constraint structure II 5-1 by the lateral bilateral sliding constraint surface 2-3. The bottom of the longitudinal sliding constraint structure II 5-1 is connected to the bottom of the LV-link portion III 7 by groups of the longitudinal elastic elements II 5-2 and the longitudinal damping elements II 5-3 in parallel. The exterior surface of the longitudinal sliding structure II 5-1 is connected to the interior surface of the LV-link portion III 7 by the longitudinal bilateral sliding constraint surface II 5-4.

The longitudinal sliding constraint structure II 5-1 and the lateral sliding structure 2-4, which is fixed on the spacecraft-link portion 1, construct a lateral sliding pair which only allows the spacecraft-link portion 1 to translate along the lateral direction relative to the longitudinal sliding constraint structure II 5-1. The exterior surface of the lateral sliding structure 2-4 is connected to the interior surface of the lateral sliding constraint structure II 5-1 by groups of the lateral elastic elements 2-1 and the lateral damping elements 2-2 in parallel, which will attenuate/isolate the lateral vibration load. The LV-link portion III 7 and the longitudinal sliding constraint structure II 5-1 construct a longitudinal sliding pair which only allows the longitudinal sliding constraint structure II 5-1 to translate along the longitudinal direction relative to the LV-link portion III 7. The bottom of the longitudinal sliding constraint structure II 5-1 is connected to the bottom of the LV-link portion III 7 by groups of the longitudinal elastic elements II 5-2 and the longitudinal damping elements II 5-3 in parallel, which will attenuate/isolate the longitudinal vibration load.

1. A device for connecting a spacecraft to a launch vehicle, which device comprises:
A) A spacecraft (SC) link portion which connects the device to the spacecraft;
B) A launch vehicle (LV) link portion which connects the device to the LV;
C) And at least one vibration attenuation/isolation portion which reduces the transmission of vibrational forces between the LV and SC.

2. The device of claim 1, wherein the vibration attenuation/isolation portion is a longitudinal vibration attenuation/isolation portion.

3. The device of claim 1, wherein the vibration attenuation/isolation portion is a lateral vibration attenuation/isolation portion.

4. The device of claim 1, which comprises both a longitudinal vibration attenuation/isolation portion and a lateral vibration attenuation/isolation portion.

5. An uncoupled WSVA/I device of claim 1, wherein the vibration attenuation/isolation portion comprises at least an elastic element, at least a damping element and a bilateral sliding constraint surface.

6. The device of claim 5, wherein the damping element is a viscosity liquid damper, an electromagnet eddy damper, a magnetorheological damper, or a friction damper.

7. The device of claim 5, wherein the elastic element is a helical spring, laminated spring, leaf spring, or metal rubber or rubber element.

8. The device of claim 5, wherein the sliding constraint surface is a nearly frictionless surface or a frictional surface that can dissipate vibration energy.

9. The device of claim 1, wherein the break frequency (isolation frequency) in the longitudinal direction of the device and the break frequency (isolation frequency) in the lateral direction of the device are independently chosen.

10. A method to design a vibration control device for connecting two structures to form an assembly, said method comprising: incorporating into the vibration control device means to separate vibrations transmitted between the two structures into vibrational load components that are substantially perpendicular to each other, and incorporating into the vibration control device at least one elastic element and/or damping element to attenuate and/or isolate each of these vibrational load components.

11. The method of claim 10, wherein the means to separate vibrations comprises a pair of perpendicular bilateral sliding constraint surfaces that separate vibrations transmitted between the two structures into components that are substantially perpendicular to each other, and wherein each bilateral sliding constraint surface directs one component of the vibrational force to at least one elastic element and/or one damping element.

12. A method to control vibrations in an assembly of two structures, said method comprising: linking the two structures together with a vibration control device, which device comprises a pair of bilateral sliding constraint surfaces perpendicular to each other that separate vibrational loads transmitted between the two structures into force components that are substantially perpendicular to each other, wherein said vibration control device also comprises at least one damping element and/or one elastic element to reduce vibrations transmitted between the two structures.
